(19) United States
(12) Patent Application Publication
(10) Pub. No.: US 2011/0085674 A1
(43) Pub. Date: Apr. 14, 2011

(54) ENGINE SOUND GENERATION APPARATUS AND METHOD

(75) Inventor: Naoki FUJIKAWA, Hamamatsu-shi (JP)

(73) Assignee: Yamaha Corporation, Hamamatsu-shi (JP)

(21) Appl. No.: 12/903,089

(22) Filed: Oct. 12, 2010

(30) Foreign Application Priority Data
Oct. 13, 2009 (JP) 2009-236591

(51) Int. Cl. H04B 1/00

(52) U.S. Cl. 381/86

(57) ABSTRACT

Velocity of an actual vehicle is detected and then converted into a virtual velocity in accordance with a velocity range of a pre-assumed model vehicle. Velocity-vs.-number-of-rotation correspondence relationship storage stores therein correspondence relationship between traveling velocities and numbers of engine rotations of the model vehicle, and information indicative of the number of engine rotations of the model vehicle is generated by referencing the storage with the virtual velocity. Engine sound data are synthesized which correspond to the generated information indicative of the number of engine rotations of the model vehicle. The number of engine rotations of the model vehicle may be imparted with fluctuation on the basis of random numbers. Gear position of the model vehicle may be simulated on the basis of the virtual velocity, and engine sound data of a characteristic of the gear position may be generated.

### BACKGROUND

The present invention relates to an engine sound generation apparatus and method.

Apparatus have been known which generate engine sound etc. of a vehicle using parameters, such as a detected accelerator opening degree, rotation speed of the engine, etc. For example, an apparatus disclosed in Japanese Patent Application Publication No. 2000-010576 is constructed to generate synthesized sound data of engine sound on the basis of throttle opening degree data and engine rotation speed data.

However, if data assuming a vehicle (or model vehicle) different in type of the vehicle in question are used as engine sound data, velocity regions, numbers of engine rotations, accelerator opening degrees of the model vehicle may sometimes not correspond to those of the vehicle in question, and no consideration has been given about how desired engine sound can be synthesized.

### SUMMARY OF THE INVENTION

In view of the foregoing, it is an object of the present invention to provide an improved engine sound generation apparatus and method which can generate engine sound using number-of-engine-rotation information generated on the basis of traveling velocity information of a vehicle.

In order to accomplish the above-mentioned object, the present invention provides an improved engine sound generation apparatus, which comprises: a velocity detection section which detects a velocity of an actual vehicle; a velocity conversion section which converts the velocity, detected by the velocity detection section, into a virtual velocity on the basis of a first particular velocity specified within a traveling velocity range of the actual vehicle and a second particular velocity specified within a traveling velocity range of a pre-assumed model vehicle; a number-of-engine-rotation generation section which, on the basis of the virtual velocity, generates information indicative of a number of engine rotations of the model vehicle; and an engine sound generation section which generates synthesized engine sound data corresponding to the number of engine rotations of the model vehicle.

According to the present invention, velocity information of the actual vehicle detected by the velocity detection section is converted, in accordance with the traveling velocity range of the pre-assumed model vehicle, to thereby obtain virtual velocity information, and then, synthesized engine sound data are generated on the basis of the virtual velocity information. In this way, the present invention can generate virtual engine sound corresponding to the velocity range of the model vehicle on the basis of the traveling velocity of the actual vehicle.

In a preferred embodiment of the present invention, the engine sound generation section includes an engine sound data storage section storing therein engine sound data corresponding to the number of engine rotations of the model vehicle, and the engine sound generation section uses the engine sound data, stored in the engine sound data storage section, to generate the synthesized engine sound data corresponding to the information indicative of a number of engine rotations of the model vehicle generated by the number-of-engine-rotation generation section.

According to a preferred embodiment of the present invention, the engine sound generation further comprises a velocity-vs.-number-of-rotation correspondence relationship storage section which stores therein correspondence relationship between traveling velocities and numbers of engine rotations of the model vehicle, and the number-of-engine-rotation generation section generates the information indicative of a number of engine rotations of the model vehicle on the basis of the correspondence relationship stored in the velocity-vs.-number-of-rotation correspondence relationship storage section and the virtual velocity determined by the velocity conversion section.

According to a preferred embodiment of the present invention, the engine sound generation apparatus further comprises a random number generation section which generates random numbers within a predetermined range, and the number-of-engine-rotation generation section imparts fluctuation to the number of engine rotations of the model vehicle on the basis of the random numbers generated by the random number generation section.

According to a preferred embodiment of the present invention, the engine sound generation apparatus further comprises an input section operable by a human operator to input the first particular velocity, and where the particular velocity is a maximum velocity of the model vehicle.

According to another preferred embodiment of the present invention, the engine sound generation apparatus further comprises an accelerator opening degree detection section which detects an accelerator opening degree of the actual vehicle, and the engine sound generation section generates synthesized engine sound data corresponding to the number of engine rotations and the accelerator opening degree of the model vehicle.

The present invention may be constructed and implemented not only as the apparatus invention as discussed above but also as a method invention. Also, the present invention may be arranged and implemented as a software program for execution by a processor such as a computer or DSP, as well as a storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing a general construction of an engine sound generation apparatus according to an embodiment of the present invention;

FIG. 2 is a graph explanatory of vehicle velocity regions of an actual vehicle and a model vehicle;

FIG. 3 is a graph explanatory of gear-specific vehicle velocity region setting information;

FIG. 4 is a graph explanatory of gear-specific vehicle velocity region setting information;

FIG. 5 is a flow chart of a process in which the engine sound generation apparatus generates information indicative of the number of engine rotations;

FIGS. 6A and 6B are graphs comparing a vehicle velocity of the actual vehicle and a detected vehicle velocity;

FIGS. 7A to 7C are graphs explanatory of vehicle velocity change tendencies;

FIGS. 8A and 8B are diagrams explanatory of accelerator opening degree correction;

FIGS. 9A to 9C are diagrams explanatory of accelerator opening degree correction values;

FIG. 10 is a diagram showing example variation over time of a vehicle velocity, number of engine rotations and accelerator opening degree when a transmission is shifted down;

FIG. 11 is a diagram showing example variation over time of the vehicle velocity, number of engine rotations and accelerator opening degree when the transmission is shifted up;

FIG. 12 is a flow chart of a process in which the engine sound generation apparatus generates information indicative of an accelerator opening degree

FIG. 13 is a diagram explanatory of engine sound generation by an engine sound generation section; and

FIG. 14 is a block diagram showing an overall construction of an engine sound apparatus according to Modification 1 of the present invention.

### DETAILED DESCRIPTION

FIG. 1 is a block diagram showing a general construction of an engine sound generation apparatus 10 according to an embodiment of the present invention. The engine sound generation apparatus 10 includes a detection section group 20, a storage section 30, a processing section 40, an engine sound generation section 50 and an operation section 60, and the engine sound generation apparatus 10 generates engine sound using these components. The detection section group 20 includes a vehicle velocity detection section 210 for detecting a traveling velocity of a vehicle (hereinafter referred to as “vehicle velocity”), and an acceleration detection section 220 for detecting acceleration of the vehicle. For example, the vehicle velocity detection section 210 includes a sensor mounted on a shaft, which rotates wheels of the vehicle in response to operation of a prime mover of the vehicle, for detecting the number of rotations of the shaft. The vehicle velocity detection section 210 detects a vehicle velocity on the basis of the number of rotations detected by the sensor. The vehicle velocity detection section 210 generates information indicative of a value of the detected vehicle velocity (this information will hereinafter be referred to as “vehicle velocity information”) and outputs the thus-generated vehicle velocity information to the processing section 40. The acceleration detection section 220, which is provided on the vehicle, includes a sensor for detecting acceleration of the vehicle. Of the detected acceleration, the acceleration detection section 220 outputs, to the processing section 40, information indicative of a value of acceleration in a traveling direction of the vehicle (this information will hereinafter be referred to as “acceleration information”). Note that the acceleration detection section 220 may determine acceleration by performing arithmetic operations, such as differentiation, on the vehicle velocity information.

The storage section 30 stores therein information indicative of various characteristics of a vehicle that actually travels with the engine sound generation apparatus 10 mounted thereon (this vehicle will hereinafter referred to as “actual vehicle R”) and various characteristics of a vehicle pre-assumed as a model of engine sound to be generated by the engine sound generation apparatus 10 (this vehicle will hereinafter referred to as “model vehicle M”). Vehicle setting information 310 is information indicative of settings of outer circumferential lengths of tires, transmission gear ratios (also referred to simply as “gears”), etc. of the model vehicle M. Vehicle velocity region setting information 320 is information indicative of settings of ranges of vehicle velocities of the actual vehicle R and model vehicle M. Velocity-vs.-number-of-rotation correspondence relationship setting information 330 is information indicative of correspondence relationship between traveling velocities and numbers of rotations of the model vehicle in association with individual gear ratios of a transmission (hereinafter referred to simply as “gears”) of the model vehicle. Fixed-gear-time accelerator opening degree setting information 340 is setting information to be used in generating an accelerator opening degree on the basis of vehicle velocity information of the actual vehicle R through the operations to be described below. Shift-change-time accelerator opening degree setting information 350 is setting information to be used in generating an accelerator opening degree during a shift change through operations to be described below. In the instant embodiment, the actual vehicle R represents the “vehicle” in the claimed invention, and a plurality of number-of-rotation ratios achieved by combinations of the plurality of gears of the transmission represent “gear positions” in the claimed invention.

The processing section 40 includes a CPU (Central Processing Unit) 410, a ROM (Read-Only Memory) 420 having stored therein programs etc. for use by the CPU 410, and a RAM (Random Access Memory) 430 for use as a working area of the CPU 410. These components 410, 420 and 430 together constitute an ordinary computer. The processing section 40 processes information of the actual vehicle R, detected and output by the vehicle velocity detection section 210 and acceleration detection section 220, on the basis of various information stored in the storage section 30. Through such processing, the processing section 40 generates information indicative of values of the number of engine rotations and accelerator opening degree which are to be used for generating engine sound. The processing section 40 outputs the thus-generated information to an engine sound generation section 50.

The engine sound generation section 50 includes an engine sound data storage section 510 for storing engine sound data indicative of a waveform of engine sound of the model vehicle M. The engine sound generation section 50 generates engine sound data, corresponding to states in which the actual vehicle R is being driven, using the engine sound data and the information of the number of engine rotations and accelerator opening degree input from the processing section 40. The engine sound generation section 50 outputs a signal indicative of the generated engine sound data, to not-shown external output devices, such as an amplifier, speaker, etc., so that engine sound is audibly generated through the output devices. The operation section 60 has functions of a plurality of buttons or a touch panel etc. so that it can function as a means operable by a user to give selection, check, confirmation, cancellation and other instructions, and it outputs information indicative of content of user's operation to the processing section 40. The model vehicle M may be of a different type (sedan, sports, coupe, truck, bus, or the like) and traveling performance from the actual vehicle R. For example, where the actual vehicle R is an ordinary type vehicle, engine sound of a racing car may be generated as engine sound of the model vehicle M. Alternatively, an imaginary vehicle appearing in a movie or animation may be assumed as the model vehicle M.

In order to reproduce engine sound of the model vehicle M, the embodiment of the engine sound generation apparatus 10 creates virtual operating states of the model vehicle M on the basis of information acquired from the actual vehicle R. Among such operating states is the number of engine rotations. The engine sound generation apparatus 10 generates information indicative of the number of engine rotations on the basis of information indicative of a gear and vehicle velocity of the model vehicle M. At that time, however, if the velocity range (hereinafter referred to also as “vehicle velocity region”) greatly differs between the model vehicle M and the actual vehicle R, the number of engine rotations of the actual vehicle R used as-is corresponds only to part of a range of the engine rotations of the model vehicle M; thus, if the number of engine rotations of the actual vehicle R is used as-is, it is not possible to obtain a desired number of engine rotations assuming the model vehicle R.

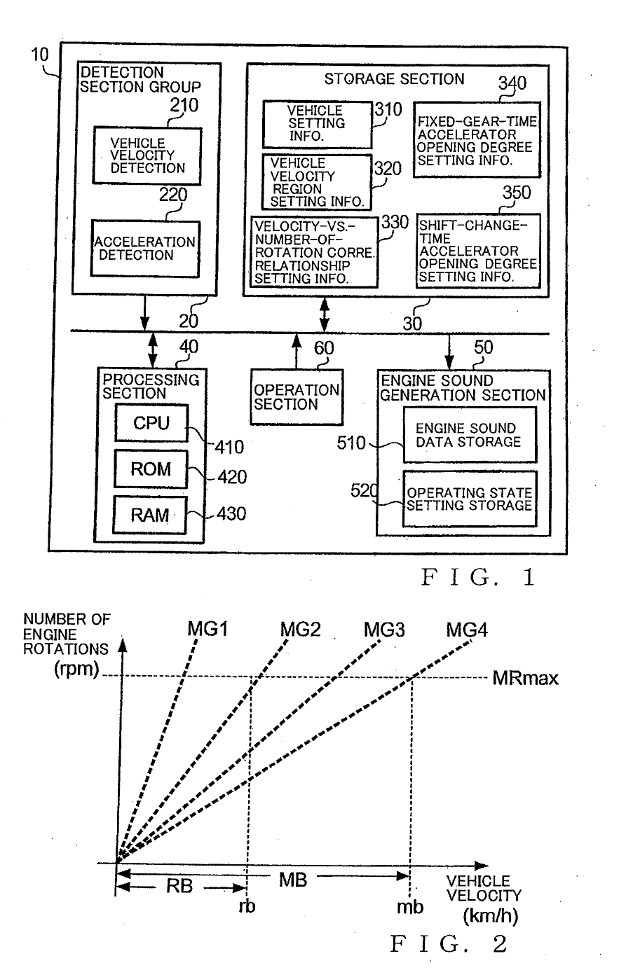

FIG. 2 is a graph explanatory of the vehicle velocity regions of the actual vehicle R and model vehicle M. In FIG. 2, the vertical axis represents the number of engine rotations (rpm), while the horizontal axis represents the vehicle velocity (km/h). “RB” indicates the vehicle velocity region of the actual vehicle R, and “rb” indicates a maximum velocity or a near-maximum velocity of the actual vehicle R specified in the vehicle velocity region RB. “MB” indicates the vehicle velocity region of the model vehicle M, and “mb” indicates a maximum velocity or a near-maximum velocity, achievable by the traveling performance, of the model vehicle M specified in the vehicle velocity region MB. In the case where the model vehicle M is a virtual vehicle, the maximum velocity or a near-maximum velocity mb may be a virtually-set particular velocity. The velocity rb represents a first particular velocity in the claimed invention, while the velocity mb is a second particular velocity in the claimed invention.

Further, in FIG. 2, gears MG1, MG2, MG3 and MG4 each represent correspondence relationship between the numbers of engine rotations and the vehicle velocities when the gear of the model vehicle M is at the first gear position, second gear position, third gear position and fourth gear position, respectively. In the instant embodiment, the vehicle velocity and the number of engine rotation in the model vehicle M has a linear correspondence relationship differing in inclination from one gear to another. “MRmax” indicates a maximum number of engine rotations determined by the performance of the engine employed in the model vehicle M. The following description will be given in relation to the model vehicle M having traveling characteristics shown in FIG. 2. Whereas the model vehicle M shown in FIG. 2 has four gear positions as an illustrative example, the model vehicle M may have a different number of gear positions than four. Further, although it is desirable that the number of engine rotations and the vehicle velocity have a linear correspondence relationship with each other as shown in FIG. 2. Alternatively, the number of engine rotations and the vehicle velocity may be in a curved correspondence relationship or in a correspondence relationship having singularity. For example, the correspondence relationship may be such that the number of engine rotations slowly increases in a low velocity region and rapidly increases once the vehicle velocity reaches a high velocity region.

The engine sound generation apparatus 10 generates information indicative of the number of engine rotation on the basis of the information of the gear and vehicle velocity of the model vehicle M, as noted above. In the case where the model vehicle M differs in traveling performance from the actual vehicle R, the vehicle region differs between the model vehicle M and the actual vehicle R as seen in FIG. 2, and thus, if the number of engine rotations of the model vehicle M is determined using the vehicle velocity of the actual vehicle R as-is, a desired number of engine rotations cannot be obtained. Namely, even when the actual vehicle R is at the maximum or near-maximum velocity rb, the numbers of engine rotations at the gear positions MG3 and MG4 are not so great, and thus, high-rotation engine sound cannot be generated at all of the four gear positions in the vehicle velocity region RB. Therefore, the engine sound generation apparatus 10 converts the vehicle velocity of the actual vehicle R, detected by the vehicle velocity detection section 210, into a virtual maximum velocity (hereinafter referred to as “virtual vehicle velocity” or “virtual velocity”) of the model vehicle M using the following mathematical expression based on a ratio between the above-mentioned velocities rb and mb:

Virtual Vehicle Velocity(mm/min)=Vehicle Velocity(mm/min)of

Actual Vehicle R×Maximum Velocity(km/h)of Model Vehicle M÷

Maximum Velocity(km/h)of Actual Vehicle R

By such vehicle velocity conversion of the actual vehicle R, the engine sound generation apparatus 10 acquires the virtual vehicle velocity in operating states of the model vehicle M that correspond to operating states of the actual vehicle R. Then, the engine sound generation apparatus 10 judges a gear of the model vehicle M in the aforementioned operating states on the basis of the acquired virtual vehicle velocity and velocity-vs.-number-of-rotation correspondence relationship setting information 330. The velocity-vs.-number-of-rotation correspondence relationship setting information 330 includes setting information to be used as a judgment criterion of the gear when the actual vehicle R is accelerating or decelerating, and setting information to be used as a judgment criterion of the gear when the actual vehicle R is traveling at a constant velocity. Note that the term “maximum velocity” is used herein to refer to a maximum velocity assumed when the vehicle is traveling, rather than a maximum limit of the performance of the vehicle; however, the “maximum velocity” may represent such a maximum limit of the performance of the vehicle. For example, the “maximum velocity” may be a legal-limit velocity. Also note that any other suitable mathematical expression than the aforementioned may be used for the vehicle velocity conversion.

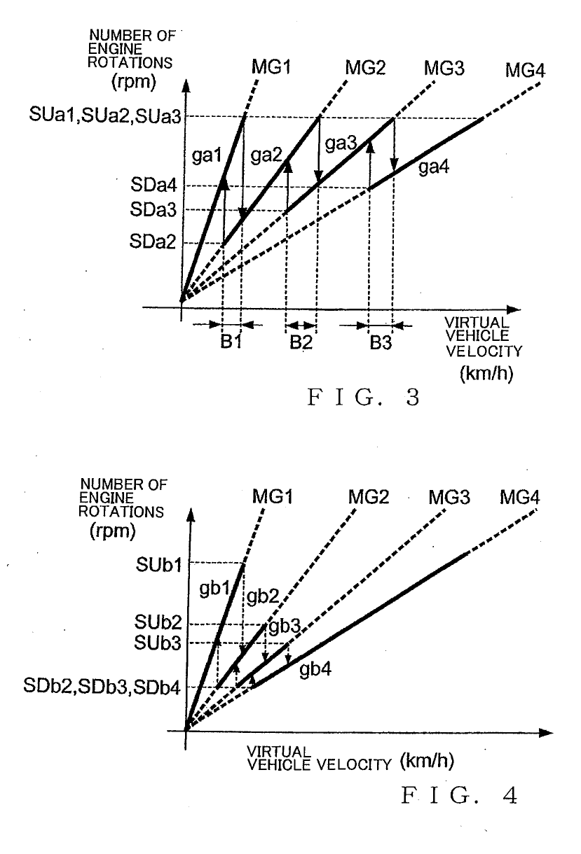

FIG. 3 is a graph explanatory of the velocity-vs.-number-of rotation correspondence relationship setting information 330 to be referenced when the actual vehicle R is accelerating or decelerating, where the vertical and horizontal axes and the inclinations of the correspondence relationship of the individual gears MG1, MG2, MG3 and MG4 are similar to those in FIG. 2. FIG. 3 shows regions ga1, ga2, ga3 and ga4 (these regions will hereinafter be generically referred to as “region ga” in cases where they need not be distinguished from one another) where the gears MG1, MG2, MG3 and MG4 are selected with respect to virtual vehicle velocities of the model vehicle M. When the virtual vehicle velocity is in the region ga1, the engine sound generation apparatus 10 generates the number of engine rotations using the velocity-vs.-number-of rotation correspondence relationship corresponding to the gear MG1. As the virtual vehicle velocity increases in response to acceleration of the actual vehicle R, the number of engine rotations generated reaches a shift-up number of engine rotations SUa1 and then gets out of the region ga1. At that time, the engine sound generation apparatus 10 shifts the gear-specific velocity-vs.-number-of rotation correspondence relationship, which is to be used for generation of the number of engine rotations, to that of the gear MG2. After that, as long as the actual vehicle R is accelerating, the engine sound generation apparatus 10 shifts the gear-specific velocity-vs.-number-of rotation correspondence relationship to that of the next upper gear MG3 or MG4 at each of the shift-up numbers of engine rotations SUa2 and SUa3. Note that, although the shift-up numbers of engine rotations SUa1, SUa2 and SUa3 are set at the same number in the illustrated example, the shift-up numbers of engine rotations SUa1, SUa2 and SUa3 may be set at different numbers.

When the actual vehicle R is decelerating, on the other hand, the engine sound generation apparatus 10 shifts the gear-specific velocity-vs.-number-of rotation correspondence relationship to that of the next lower gear MG1, MG2 or MG3 once the number of engine rotations decreases to reach any one of the shift-up numbers of engine rotations SDa2, SDa3 and SDa4. In the aforementioned manner, the engine sound generation apparatus 10 effects a gear change or shift such that the transmission shifts up or shifts down (i.e., an upshift or downshift of the transmission occurs) at a preset vehicle velocity in response to increase or decrease of the acquired virtual velocity. Then, the engine sound generation apparatus 10 selects gear-specific velocity-vs.-number-of rotation correspondence relationship corresponding to the shifted-to gear (ratio) with reference to the above-mentioned velocity-vs.-number-of-rotation correspondence relationship setting information 330.

At that time, the region ga1 and the region ga2 overlap with each other in the virtual vehicle velocity region B1 shown in FIG. 3. In such a virtual vehicle velocity region. B1, the engine sound generation apparatus 10 generates information indicative of the number of engine rotations using the gear MG1 or MG2 depending on traveling states of the actual vehicle R. The engine sound generation apparatus 10 behaves similarly to the above in virtual vehicle velocity regions B2 and B3. In these regions, the gear to be used for generation of the number of engine rotations is not shifted to the next upper gear MG2, MG3 or MG4 even when the travel of the actual vehicle R has shifted from acceleration to deceleration, unless the number of engine rotations generated exceeds any one the shift-up numbers of engine rotations SUa1, SUa2 and SUa3. Likewise, the gear to be used for generation of the number of engine rotations is not shifted to the next lower gear MG1, MG2 or MG3 even when the travel of the actual vehicle R has shifted from deceleration to acceleration, unless the number of engine rotations generated falls below any one of the shift-down numbers of engine rotations SDa2, SDa3 and SDa4. Namely, the engine sound generation apparatus 10 effects the gear shift such that the vehicle velocity at which a downshift from a particular gear occurs is smaller than the vehicle velocity at which an upshift to a particular gear occurs. A region between these velocities will hereinafter be referred to as “dead vehicle velocity region”. Because of the provision of the “dead vehicle velocity region”, the relationship between the number of engine rotations and the vehicle velocity presents a hysteresis characteristic between an upshift and downshift of the transmission as shown in the figure.

FIG. 4 is a graph explanatory of the velocity-vs.-number-of rotation correspondence relationship setting information 330 to be referenced when the actual vehicle R is traveling at a constant velocity. In FIG. 4, the vertical and horizontal axes and the inclinations of the individual gears MG1, MG2, MG3 and MG4 are similar to those in FIG. 2. FIG. 4 shows regions gb1, gb2, gb3 and gb4 (these regions will hereinafter be generically referred to as “region gb” in cases where they need not be distinguished from one another) where the respective gears MG1, MG2, MG3 and MG4 are selected with respect to virtual vehicle velocities of the model vehicle M. When the actual vehicle R is traveling at a constant velocity, the engine sound generation apparatus 10 generates information indicative of the number of engine rotations using a higher gear than those used at the time of acceleration and deceleration. Thus, the region gb is set in such a manner that the vehicle velocity at which an upshift or downshift of the transmission occurs is lower than that in the aforementioned region ga. Further, the region gb is set such that the number of engine rotations generated would not fall below a preset range. Namely, even for a same virtual vehicle velocity, the number of engine rotations generated would become smaller than those at the time of acceleration and deceleration of the actual vehicle R. The engine sound generation apparatus 10 determines, on the basis of acceleration information detected by the acceleration detection section 220, whether or not the actual vehicle R is traveling at a constant velocity.

Generally, the engines rotate with its explosion interval fluctuating (such explosion interval fluctuation will hereinafter be referred to simply as “fluctuation”). To reproduce such fluctuation, the instant embodiment of the engine sound generation apparatus 10 uses random numbers generated within a range predetermined in accordance with characteristics of the engine of the model vehicle M. In the instant embodiment, it is assumed that the predetermined range is from zero to a predetermined upper-limit value defining a fluctuation width (this predetermined upper-limit value will be referred to as “fluctuation value”). Namely, the processing section 40 generates random numbers within the range from zero to the fluctuation value and performs a process for imparting fluctuation to the number of engine rotations on the basis of the generated random numbers. For example, the generated random numbers may be added to the number of engine rotations, or the number of engine rotations may be calculated by substituting the number of engine rotations and random number into a predetermined function.

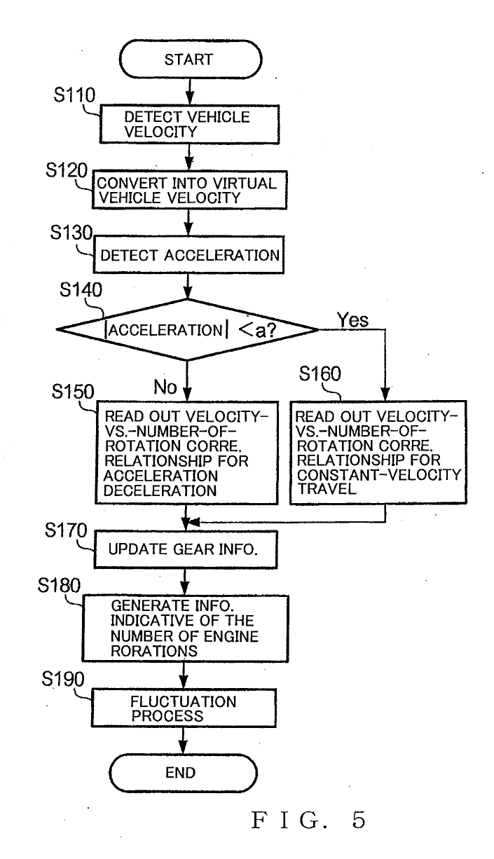

FIG. 5 is a flow chart of a process in which the engine sound generation apparatus 10 generates information indicative of the number of engine rotations. First, at step S110, the engine sound generation apparatus 10 detects a vehicle velocity of the actual velocity R. Then, at step S120, the engine sound generation apparatus 10 converts the detected vehicle velocity into a virtual vehicle velocity on the basis of the vehicle velocity region setting information 320 stored in the storage section 30. At next step S130, the engine sound generation apparatus 10 detects acceleration of the actual vehicle R. Then, at step S140, the engine sound generation apparatus 10 determines whether or not the absolute value of the detected acceleration is smaller than a preset value “a”. If the absolute value of the detected acceleration is equal to or greater than the preset value “a” (NO determination at step S140), the engine sound generation apparatus 10 reads out, at step S150, the velocity-vs.-number-of-rotation correspondence relationship setting information 330 to be referenced when the actual vehicle R is accelerating or decelerating. Note that the above-mentioned order of steps S110, S120 and S130 may be reversed.

If the absolute value of the detected acceleration is smaller than the preset value “a” (YES determination at step S140), the engine sound generation apparatus 10 reads out, at step S160, the velocity-vs.-number-of-rotation correspondence relationship setting information 330 to be referenced when the actual vehicle R is traveling at a constant velocity. Then, at step S170, the engine sound generation apparatus 10 updates information of the gear (i.e., gear information), which is to be used for generation of information indicative of the number of engine rotations, on the basis of the read-out setting information and virtual vehicle velocity. At next step S180, the engine sound generation apparatus 10 generates information indicative of the number of engine rotations of the model vehicle on the basis of the updated setting information and virtual vehicle velocity and the velocity-vs.-number-of-rotation correspondence relationship setting information 330. Then, at step S190, the engine sound generation apparatus 10 performs a fluctuation process for generating the above-mentioned random numbers and adding the thus-generated random numbers to the generated number of engine rotations.

The following describe how the accelerator opening degree is acquired from the vehicle velocity of the actual vehicle R. A human driver driving the actual vehicle R adjusts the accelerator opening degree by pressing an accelerating control (not shown), which is operable to operate the accelerator opening degree, so as to move the accelerating control within a predetermined range. For example, the accelerator opening degree is 0% when the accelerating control is not being operated, and 100% when the accelerating control is at a maximum limit position of the predetermined range. The opening degree when the accelerating control is not being operated at all is prestored by the processing section 40 in the RAM 430 as an initial accelerator opening degree value “0” (%), although any other suitable value may be set as the initial accelerator opening degree value. The accelerator opening degree value stored in the RAM 430 will hereinafter be referred to as “accelerator opening degree A”. The accelerator opening degree A is a value which is sequentially updatable by the processing section 40 and is indicative of a current value of the accelerator opening degree. The accelerator opening degree A may be stored in any suitable section updatable by the processing section 40 other than the RAM 430. Once the vehicle starts traveling, the processing section 40 calculates a current value of the accelerator opening degree A on the basis of the gear and change tendency of the vehicle velocity. Such a vehicle velocity change is acquired on the basis of vehicle velocities detected by the vehicle velocity detection section 210. The following describe vehicle velocities detected by the vehicle velocity detection section 210.

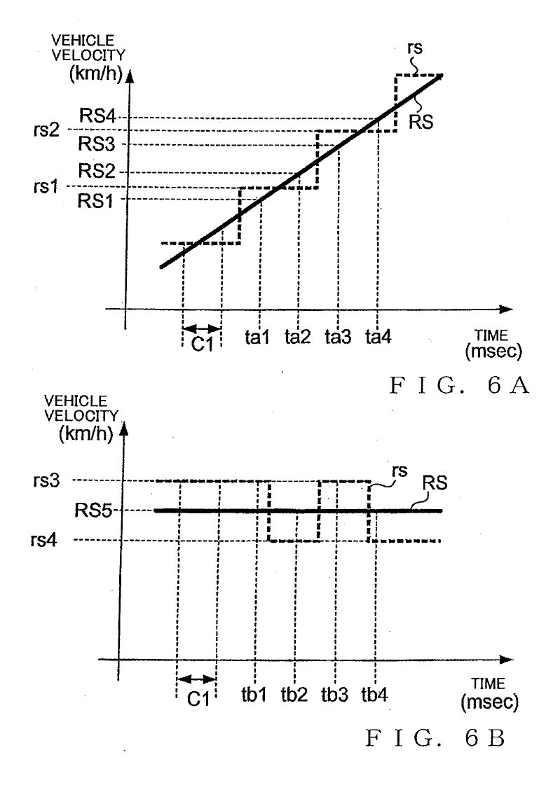

FIG. 6 is a graph comparing the vehicle velocity of the actual vehicle R and a detected vehicle velocity. In FIG. 6, C1 indicates a cyclic period C1 in which the vehicle velocity detection section 210 detects a vehicle velocity of the actual vehicle R and outputs the detected vehicle velocity to the processing section 40. The cyclic period C1 has a length predetermined on the basis of characteristics of the engine of the model vehicle M, performance of the sensor of the vehicle velocity detection section 210, and/or the like. In the instant embodiment, it is assumed that the cyclic period C1 has a length of 20 msec. More specifically, FIG. 6A shows a vehicle velocity rs detected per period C1 and an actual vehicle velocity RS when the actual vehicle R is in an accelerating state.

The vehicle velocity detection section 210 in the instant embodiment detects a vehicle velocity in units of 1 km/h (i.e., at a resolution of 1 km/h). This unit (i.e., 1 km/h) indicates an ability for the vehicle velocity detection section 210 to resolve the velocity, and this ability will hereinafter be referred to as “velocity resolution”. More specifically, in the illustrated example of FIG. 6A, the vehicle velocity detection section 210 detects a vehicle velocity rs1 at time points ta1 and ta2, and a vehicle velocity rs2 at time points ta3 and ta4. The vehicle velocity rs2 is higher than the vehicle velocity rs1 by 1 km/h. Thus, even when the vehicle velocity of the actual vehicle R has changed by an amount smaller than the velocity resolution of the vehicle velocity detection section 210 during the cyclic period C1, this vehicle velocity change is not detected by the vehicle velocity detection section 210.

FIG. 6B is a graph showing detected vehicle velocities rs and an actual vehicle velocity RS when the actual vehicle R is traveling at a constant vehicle velocity. The actual vehicle velocity RS of the vehicle R remains constant at RS5 from time point tb1 to tb4. On the other hand, the vehicle velocity detection section 210 detects a vehicle velocity rs3 at time points tb1 and tb3, and a vehicle velocity rs4 at time points tb2 and tb4. The vehicle velocity rs3 is higher than the vehicle velocity rs4 by 1 km/h. Namely, as the actual vehicle R travels at the vehicle velocity RS5 that is in between the vehicle velocities rs3 and rs4 detectable by the vehicle velocity detection section 210, the vehicle velocity detection section 210 detects the vehicle velocities rs3 and rs4 in a repetitive fashion. Thus, the engine sound generation apparatus 10 cannot judge that the actual vehicle R is traveling at the constant vehicle velocity. In order to detect a vehicle velocity undetectable due to the velocity resolution of the vehicle velocity detection section 210, the engine sound generation apparatus 10 is constructed to detect a tendency with which the vehicle velocity of the actual vehicle R changes (this tendency will hereinafter be referred to as “vehicle velocity change tendency”) and judge an actual vehicle velocity on the basis of the detected vehicle velocity change tendency.

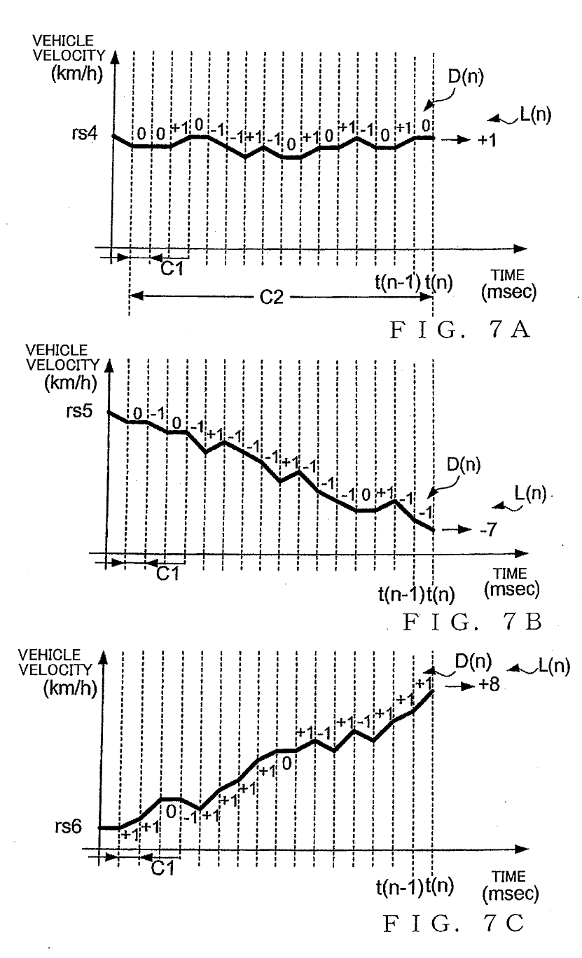

FIG. 7 is a graph explanatory of the vehicle velocity change tendency. As noted above, the vehicle velocity detection section 210 output, to the processing section 40, a vehicle velocity detected at intervals of cyclic period C1. The processing section 40 stores each vehicle velocity information, input from the vehicle velocity detection section 210, into the RAM 430. Then, the processing section 40 compares the vehicle velocity detected at time t(n) and the vehicle velocity detected at time point t(n−1) earlier than time t(n) by the cyclic period C1. If the vehicle velocity detected at time point t(n) is found higher than the vehicle velocity detected at time t(n−1) as a result of the comparison, the processing section 40 stores a value “+1” into the RAM 430 as a value determined at time point t(n) in accordance with a difference from the vehicle velocity detected at time point t(n−1). If the vehicle velocity detected at time point t(n) is found smaller than the vehicle velocity detected at time t(n−1) as a result of the comparison, on the other hand, the processing section 40 stores a value “−1” into the RAM 430 as the value determined at time point t(n) in accordance with the difference from the vehicle velocity detected at time point t(n−1). Further, if the vehicle velocity detected at time point t(n) is found equal to the vehicle velocity detected at time t(n−1), the processing section 40 stores a value “0” into the RAM 430. Such a value determined at time point t(n) in accordance with the difference from the vehicle velocity detected at the preceding time point t(n−1) will hereinafter be referred to as “vehicle velocity difference D(n)”, and as “vehicle velocity difference D” in cases where the time point is not particularly specified. In the aforementioned manner, the processing section 40 in the instant embodiment acquires the vehicle velocity difference D that is a vehicle velocity change tendency per cyclic period C1.

The processing section 40 acquires such a vehicle velocity difference D(n) per cyclic period C1 and accumulates the acquired vehicle velocity difference D(n) into the RAM 430. The cyclic period C1 is one of unit time segments (or sub periods) obtained by dividing a predetermined period C2 into a plurality of smaller periods. Once the vehicle velocity differences D(n) corresponding to the predetermined period C2 are sequentially accumulated into the RAM 430, the processing section 40 sums up the accumulated vehicle velocity differences D(n). The sum of the vehicle velocity differences D(n) indicates with what kind of tendency the vehicle velocity of the actual vehicle R changes. Namely, the processing section 40 acquires a change tendency of the period C2 on the basis of change tendencies acquired in cyclic periods C1. The period C2 has a length determined in accordance with characteristics of the engine of the model vehicle M, etc. The summed-up value of the vehicle velocity differences D(n) acquired during the period C2 lasting to time point t(n) will hereinafter be referred to as “vehicle velocity change tendency L(n)”, and as “vehicle velocity change tendency L” in cases where the time point is not particularly specified. The length of the period C2 is determined on the basis of relationship between the aforementioned cyclic period C1 and a period with which the engine sound generation is performed. For example, in the instant embodiment, it is assumed that the length of the period C2 is 320 msec. The vehicle velocity change tendency L represents “a change tendency of vehicle velocities of the vehicle R.

Vehicle velocities rs4, rs5 and rd6 shown in FIG. 7 indicate example changes of vehicle velocities of the actual vehicle R detected by the vehicle velocity detection section 210 during the period C2 lasting to time point t(n). More specifically, the vehicle velocity example rs4 of FIG. 7A indicates vehicle velocities detected when the actual vehicle R is traveling at a constant velocity. In the vehicle velocity example rs4, an operation for adding −1 in response to the vehicle velocity difference D increasing by +1 is repeated during the period C2. In the vehicle velocity example rs4, the processing section 40 acquires +1 as the vehicle velocity change tendency L(n). The vehicle velocity example rs5 of FIG. 7B indicates vehicle velocities detected when the actual vehicle R is decelerating. The vehicle velocity example rs5 includes, in the period C2, many cyclic periods C1 where the vehicle velocity difference D is −1. In the vehicle velocity example rs5, the processing section 40 acquires −7 as the vehicle velocity change tendency L(n). The vehicle velocity example rs6 of FIG. 7C indicates vehicle velocities detected when the actual vehicle R is accelerating. The vehicle velocity example rs6 includes, in the period C2, many cyclic periods C1 where the vehicle velocity difference D is +1. In the vehicle velocity example rs6, the processing section 40 acquires +8 as the vehicle velocity change tendency L(n). The processing section 40 acquires a value for correcting the accelerator opening degree A, on the basis of the vehicle velocity change tendency L(n).

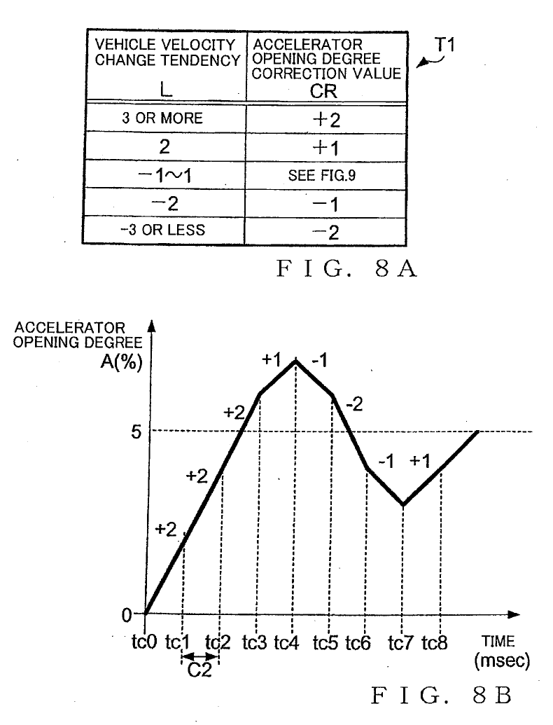

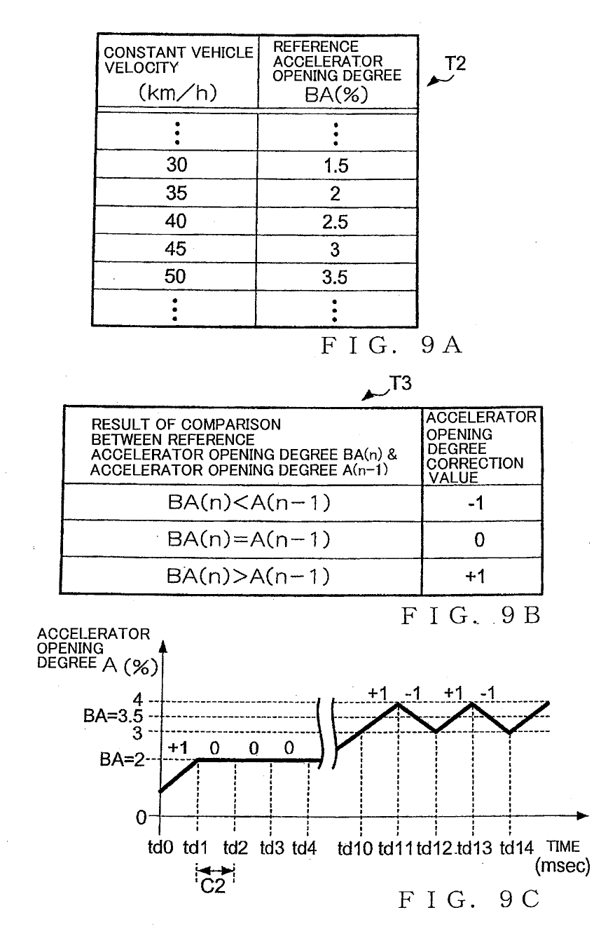

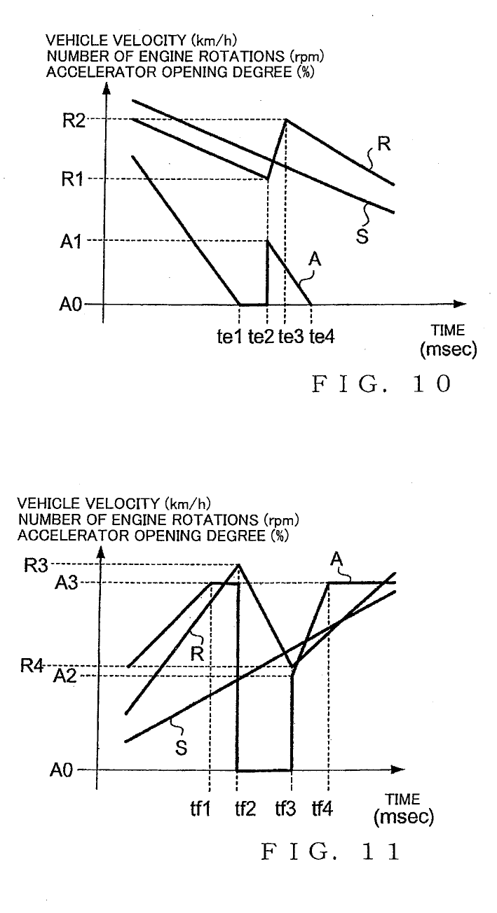

FIG. 8 is a diagram explanatory of the accelerator opening degree correction based on an accelerator opening degree correction value. FIG. 8A shows a table T1 storing correspondence relationship between values of the vehicle velocity change tendency L and accelerator opening degree correction values CR are stored. The table T1 is stored in the storage section 30 as one Fixed-gear-time accelerator opening degree setting information 340. Namely, in the table T1, the values of the vehicle velocity change tendency L and the accelerator opening degree correction values CR are associated with each other in such a manner that, where the values of the vehicles velocity change tendency L are “3 or more”, “+2”, “−2” and “−3 or less”, the accelerator opening degree correction values CR are “+2”, “+1”, “−1” and “−2”, respectively. A case where the values of the vehicle velocity change tendency L are “1”, “0” and “−1” will be described later with reference to FIG. 9. FIG. 8B is a diagram showing how the accelerator opening degree A fluctuates in accordance with the table T1. Time points tc0 to tc8 are time points changing consecutively from time point tc0 every period C2. From time point tc0 to time point tc3, +2 is added three times as the accelerator opening degree correction value CR, so that the accelerator opening degree A takes a value of 6% at time point tc3. Following time point tc3, accelerator opening degree correction values CR of “+1”, “−1”, “−2”, “−1” and “+1” are sequentially added to the accelerator opening degree A, so that the accelerator opening degree A changes to 7%, 6%, 4%, 3% and then to 4%.

FIG. 9 is a diagram explanatory of accelerator opening degree correction values when the vehicle velocity change tendency L is “1”, “0” and “−1”. When the vehicle velocity change tendency L is “1”, “0” and “−1”, it means that the actual vehicle R is traveling at a substantially constant vehicle velocity (such travel will hereinafter be referred to as “constant-velocity travel”). In this case, the accelerator opening degree is maintained approximately constant. Also, the accelerator opening degree maintained constant during the constant-velocity travel of the actual vehicle R will hereinafter be referred to as “reference accelerator opening degree BA”. The above-mentioned values “1”, “0” and “−1” of the vehicle velocity change tendency L are set within a range predetermined in accordance with traveling characteristics of the actual vehicle R, although they may be set within another range. More specifically, FIG. 9A shows a table T2 where values of the constant vehicle velocity of the actual vehicle R and values of the reference accelerator opening degree BA are stored in association with each other. The table T2 is stored in the storage section 30 as one fixed-gear-time accelerator opening degree setting information 340. The table T2 defining one example of associated relationship between values of the constant vehicle velocity of the actual vehicle R and values of the reference accelerator opening degree BA, which is set in accordance with the performance of the actual vehicle R and the performance of the model vehicle M providing engine sound.

If the vehicle velocity change tendency L(n) at time point t(n) is “1”, “0” or “−1”, the processing section 40 judges that the actual vehicle R is traveling at a substantially constant velocity. Then, the processing section 40 references the table T2 to acquire a reference accelerator opening degree BA(n) on the basis of a vehicle velocity at time point t(n) and vehicle velocity rs(n) detected at time point t(n). Then, on the basis of the acquired reference accelerator opening degree BA(n), the processing section 40 acquires an accelerator opening degree correction value using a table T3 that is different from the table T1. FIG. 9B is a diagram explanatory of the table T3 where results of comparison between the acquired reference accelerator opening degree BA(n) and an accelerator opening degree A(n−1) at time point t(n−1) earlier than time point t(n) by the period C2 and the accelerator opening degree correction values CR are stored in association with each other. The table T3 is stored in the storage section 30 as one fixed-gear-time accelerator opening degree setting information 340. In the table T3, the accelerator opening degree correction values “+1”, “0” and “−1” are associated with the reference accelerator opening degree BA(n) greater than the accelerator opening degree A(n−1), the reference accelerator opening degree BA(n) equal to the accelerator opening degree A(n−1) and the reference accelerator opening degree BA(n) smaller than the accelerator opening degree A(n−1). Namely, the table T3 indicates correction values of the accelerator opening degree based on values of the reference accelerator opening degree BA(n) and the accelerator opening degree A(n−1) stored in the RAM 430.

FIG. 9C is a diagram showing an example manner in which the accelerator opening degree A fluctuates in accordance with the tables T2 and T3. Time points td0 to td4 and td10 to td14 are time points that change consecutively every period C2. FIG. 9C shows a case where the actual vehicle R is traveling at a constant vehicle velocity from time point td0 to time point td4 and at a constant vehicle velocity from time point td10 to time point td14. Let's assume that the accelerator opening degree at time point td0 is 1(%). If the actual vehicle R travels at a velocity of 35 km/h from time point td0 to time point td3, the processing section 40 references the table 2 to acquire 2(%) as a value of the reference accelerator opening degree BA. Then, the processing section 40 compares the value of the reference accelerator opening degree BA at time point td1, i.e. 2(%) and the value of the accelerator opening degree A at time point td0, i.e. 1(%). Then, on the basis of a result of the comparison, the processing section 40 references the table T3 to acquire a value “+1” as the accelerator opening degree correction value CR. Once the accelerator opening degree correction value CR is acquired like this, the processing section 40 adds the accelerator opening degree correction value CR to the value of the accelerator opening degree A, to thereby calculate a value of the accelerator opening degree A at time point td1. In this case, the value of the accelerator opening degree A at time point td1 thus calculated is 2(%). Because the accelerator opening degree A and the reference accelerator opening degree BA are both 2(%), i.e. equal to each other, at time points td2 to td4 the accelerator opening degree correction value CR is “0”, so that the accelerator opening degree A is maintained at 2(%).

Let it be assumed that the actual vehicle R travels at a velocity of 50 km/h from time point td10 to time point td14. If the accelerator opening degree A at time point td10 is 3(%), the processing section 40 at time point td11 references the tables T2 and T3 to acquire “+1” as the accelerator opening degree correction value CR and calculate the accelerator opening degree A as 4(%). At time point td12, the processing section 40 references the tables T2 and T3 to acquire “−1” as the accelerator opening degree correction value CR and calculate the accelerator opening degree A as 3(%). Because the accelerator opening degree correction value CR is set at a resolution of 1% in the instant embodiment, if the reference accelerator opening degree BA includes a value after the decimal point, the accelerator opening degree A is calculated to repeatedly alternate between two values closest to the value of the reference accelerator opening degree BA. As set forth above, once the reference accelerator opening degree BA is acquired, the sound generation apparatus 10 updates the value of the accelerator opening degree, stored in the RAM 430, using the accelerator opening degree correction value CR corresponding to the acquired value. Note that the accelerator opening degree correction value CR may be set at a resolution smaller or greater than 1(%).

Next, a description will be given about an accelerator opening degree when a human driver of an ordinary vehicle effects a gear change or shift through downshift or upshift operation. To effect a gear change, the human driver disconnects the rotating movement of the engine from the rotating movement of the axle, adjusts the number of engine rotations in accordance with the changed gear ratio and then connect again the engine and the axle. The following describe operations performed in a manual-transmission vehicle, for example. Note that, in an automatic-transmission vehicle, the following control is performed by an automatic transmission in place of a human driver.

FIG. 10 is a diagram showing example change over time of a vehicle velocity S, number of engine rotations R and accelerator opening degree A when the transmission is shifted down. FIG. 10 shows a situation where the vehicle is decelerating, as indicated by the vehicle velocity S. Before changing gears, the human driver returns the previously operated accelerating control until the accelerator opening degree returns to 0(%). In the illustrated example, the accelerator opening degree has reached 0(%) at time point te1. Then, at time point te2, the human driver starts operation for shifting the transmission to a lower gear (ratio). First, after disconnecting the transmission from the engine, the human driver operates the accelerating control until the accelerator opening degree A reaches a predetermined degree A1 (hereinafter referred to as “shift-down accelerator opening degree A1”). As the accelerator opening degree A increases like this, the number of engine rotations R increases from R1 to R2. Then, at time point te3, the human driver connects again the transmission to the engine and returns the operated accelerating control until the accelerator opening degree reaches 0(%) again. By the human driver controlling the vehicle in the aforementioned manner, the vehicle can decelerate while achieving a greater engine brake force with a lower gear. The shift-down accelerator opening degree A1 is stored in the storage section 30 as one shift-change-time accelerator opening degree setting information 350.

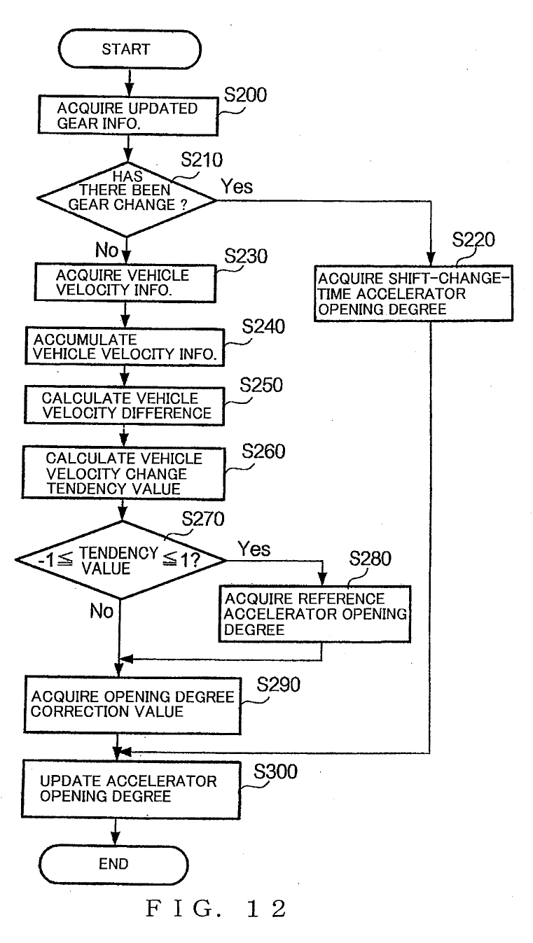

FIG. 11 is a diagram showing example change over time of the vehicle velocity S, number of engine rotations R and accelerator opening degree A when the transmission is shifted up. In FIG. 11, A0, A2 and A3 indicate values of the accelerator opening degree, and R3 and R4 indicate values of the number of engine rotations. FIG. 11 shows a situation where the vehicle is accelerating, as indicated by the vehicle velocity S. The human driver accelerates the vehicle by operating the accelerating control until the accelerator opening degree takes the value A3. The accelerator opening degree A3 indicates the greatest accelerator opening degree of the vehicle (hereinafter referred to as “maximum accelerator opening degree A3”). The human driver starts shifting up the transmission at time point tf2. First, the human driver returns the previously operated accelerating control until the accelerator opening degree reaches 0(%). In this case, the human driver performs the accelerating control returning operation at time point tf2, so that the accelerator opening degree takes a value A0; the value A0 indicates that the accelerator opening degree is currently 0(%).

After the accelerator opening degree A0 is reached, the human driver disconnects the transmission from the engine. Then, the human driver operates the accelerating control until the accelerator opening degree A reaches a predetermined value A2 (hereinafter referred to as “shift-up accelerator opening degree A2”). Let it be assumed here that the shift-up accelerator opening degree A2 is half the value of the maximum accelerator opening degree A3. Once the accelerator opening degree A reaches the shift-up accelerator opening degree A2, the human driver connects again the transmission to the engine. After connecting the transmission, the human driver operates the accelerating control until the accelerator opening degree A reaches the maximum accelerator opening degree A3. The number of engine rotations R increases with an operated amount of the accelerator opening degree A till time point tf2, then temporarily decreases till time point tf3, and then it increases again following time point tf3. Note that, in the instant embodiment of the engine sound generation apparatus 10, the shift-up accelerator opening degree A2 may be of any other desired value than half of the maximum opening degree A3. In such a case, it is only necessary that the shift-up accelerator opening degree A2 be set in accordance with operating characteristics of the model vehicle M. The shift-up accelerator opening degree A2 is stored in the storage section 30 as one shift-change-time accelerator opening degree setting information 350.

In the aforementioned manner, the engine sound generation apparatus 10 updates the accelerator opening degree A to the shift-down accelerator opening degree A1 at the time of a downshift, while it updates the accelerator opening degree to the shift-up accelerator opening degree A2 at the time of an upshift. Namely, upon detection of a shift change, the engine sound generation apparatus 10 updates the accelerator opening degree A to take the predetermined value. In the following description, the shift-down accelerator opening degree A1 and the shift-up accelerator opening degree A2 will hereinafter be generically referred to as “shift-change accelerator opening degree” in cases where they need not be distinguished from each other.

FIG. 12 is a flow chart of a process in which the engine sound generation apparatus 10 generates information indicative of an accelerator opening degree. First, at step S200, the processing section 40 acquires the gear information updated at step S170 in the number-of-engine-rotation generation process shown in FIG. 5, as well as the pre-updated (non-updated) gear information (i.e., gear information before being updated at step S170). Then, the processing section 40 determines, at step S210, whether the updated gear is different from the non-updated gear. If these gears are different from each other as determined at step S210, the processing section 40 determines that there has been a gear change (shift change) (YES determination at step S210), and then acquires the shift-change-time accelerator opening degree setting information 350 from the storage section 30 at step S220. Namely, the processing section 40 determines presence/absence of a gear change on the basis of vehicle velocity information of the actual vehicle R. In the instant embodiment, presence/absence of a gear change is determined through operation of the detection section group 20, storage section 30 and processing section 40, which together constitutes a means for determining presence of a gear change. If the gear change has been made to shift down a gear, the processing section 40 generates the shift-down accelerator opening degree A1 as a current accelerator opening degree, while, if the gear change has been made to shift up a gear, the processing section 40 generates the shift-up accelerator opening degree A2 as a current accelerator opening degree, at step S300.

If the gears are not different from each other as determined at step S210, the processing section 40 determines that there has been no shift change (NO determination at step S210), and thus, the processing section 40 performs operations of steps S230 to S300 for generating an accelerator opening degree on the basis of a vehicle velocity change tendency value. Namely, the processing section 40 first acquires vehicle velocity information of the actual vehicle R detected by the vehicle velocity detection section 210, at step S230. Then, at step S240, the processing section 40 accumulates the acquired vehicle velocity information of the actual vehicle R into the RAM 430 during the period C2. Then, at step S250, the processing section 40 calculates a vehicle velocity difference value on the basis of the accumulated vehicle velocity information. Then, at step S260, the processing section 40 calculates a vehicle velocity change tendency value on the basis of the vehicle velocity difference value. Then, at step S270, the processing section 40 determines that the calculated vehicle velocity difference value is any one of “1”, “0” and “−1”.

If the calculated vehicle velocity difference value is any one of “1”, “0” and “−1” (YES determination at step S270), the processing section 40 goes to step S280, where it references the table T2, stored in the storage section 30, to acquire a reference accelerator opening degree corresponding to the vehicle velocity information accumulated last at step S240. Then, at step S290, the processing section 40 compares the acquired reference accelerator opening degree and the accelerator opening degree at a time point earlier by the period C2, and thereby acquires an accelerator opening degree correction value by referencing the table T3 stored in the storage section. Then, the processing section 40 adds the acquired accelerator opening degree correction value to the accelerator opening degree detected at the time point earlier by the period C2, to thereby generate an accelerator opening degree. In this manner, the processing section 40 updates the value of the accelerator opening degree A, stored in the RAM 430, using the generated accelerator opening degree, and stores the thus-updated accelerator opening degree value into the RAM 430, at step S300.

If the calculated vehicle velocity difference value is not any one of “1”, “0” and “−1” (NO determination at step S270), the processing section 40 references the table T1, stored in the storage section 30, to acquire an accelerator opening degree correction value corresponding to the acquired vehicle velocity change tendency value, at step S290. The processing section 40 adds the acquired accelerator opening degree correction value to the accelerator opening degree detected at the time point earlier by the period C2, to thereby generate an accelerator opening degree. In this manner, the processing section 40 updates the value of the accelerator opening degree A, stored in the RAM 430, using the thus-generated accelerator opening degree, and stores the thus-updated accelerator opening degree value into the RAM 430, at step S300.

As set forth above, the sound generation apparatus 10 generates the number of engine rotations and accelerator opening degree on the basis of the vehicle velocity information. The following describe how the engine sound generation section 50 generates engine sound data of the model vehicle M using the generated number of engine rotations and accelerator opening degree and generates engine sound corresponding to a vehicle velocity state of the actual vehicle R.

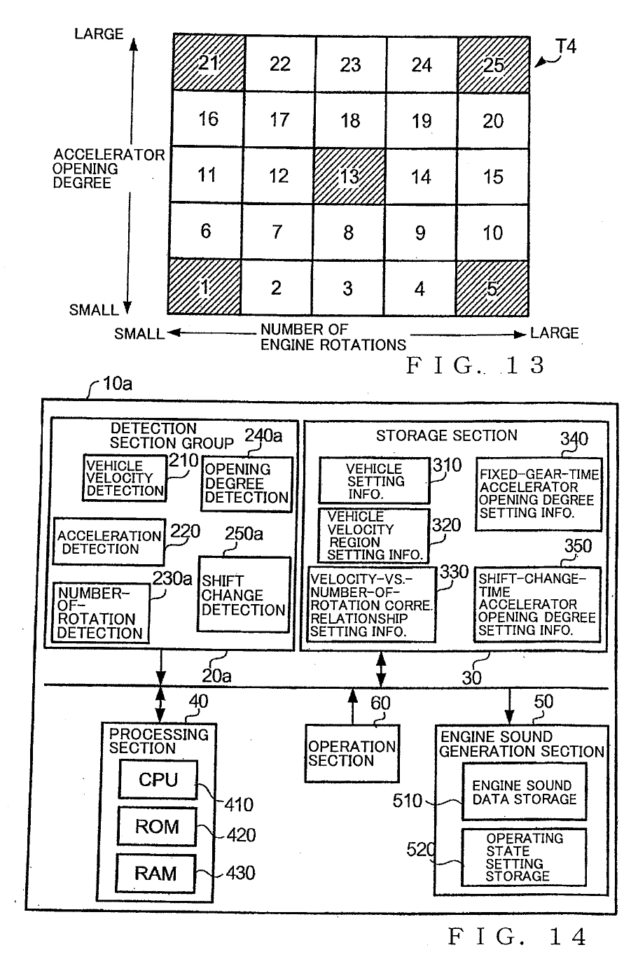

FIG. 13 is a diagram explanatory of the engine sound generation by the engine sound generation section 50. The engine sound generation section 50 has a table T4, indicative of operating states of the actual vehicle R, stored in an operating state setting storage section 520. More specifically, the table T4 stores various patterns of operating states in blocks 1 to 25 defined using numbers of engine rotations and accelerator opening degrees as parameters. Once information indicative of the number of engine rotations and accelerator opening degree are input from the processing section 40, the engine sound generation section 50 references the table T4 to determine a particular pattern of operating states of the actual vehicle R which corresponds to the input number of engine rotations and accelerator opening degree. Note that the number of the blocks storing the patterns of operating states of the actual vehicle R is not necessarily limited to twenty five as shown and may be greater or smaller than twenty five; namely, any desired number of patterns of operating states of the actual vehicle R other than twenty five may be prestored in the table T4.

The engine sound data storage section 510 has prestored therein, for each of patterns of operating states in specified vehicle velocity regions of the model vehicle M, engine sound data corresponding to the number of engine rotations and accelerator opening degree that represent that pattern of operating states. The stored engine sound data are data of an explosion portion in one combustion cycle, more specifically, data corresponding to one explosion in one cylinder. In the instant embodiment, engine sound data W1, W5, W13, W21 and W25 corresponding to patterns of operating states 1, 5, 13, 21 and 25 are prestored in the engine sound data storage section 510. The engine sound generation section 50 generates synthesized engine sound data using the engine sound data W1, W5, W13, W21 and W25 and on the basis of the updated accelerator opening degree value and acquired number-of-engine-rotation information. Note that the engine sound data prestored in the engine sound data storage section 510 may be engine sound data corresponding to some or all of possible patterns of operating states of the vehicle.

More specifically, the engine sound generation section 50 generates synthesized engine sound data by weighting the engine sound data W1, W5, W13, W21 and W25 and superposing the weighted engine sound data W1, W5, W13, W21 and W25. In the case of the operating state pattern 3, the engine sound generation section 50 sets a weight value “0.5” for the engine sound data W1 and W5 and a weight value “0” for the engine sound data W13, W21 and W25. Then, the engine sound generation section 50 mutually superposes the engine sound data W1 and W5 weighted with the 0.5 weight value, to thereby generate synthesized engine sound data for the operating state pattern 3. Further, in the case of each operating state pattern for which engine sound data have been stored, engine sound data corresponding to the operating state pattern may be weighted with a weight value “1” and the other engine sound data may be weighted with a weight value “0”. Weight settings for the individual operating state patterns may be determined in accordance with characteristics of the model vehicle M.

The engine sound data generated by the engine sound generation section 50 in the aforementioned manner are amplified by a not-shown amplifier and then output to an external speaker or the like, so that engine sound is audibly reproduced. The external speaker or the like is installed at a suitable position inside the actual vehicle R such that the human driver driving the vehicle R can easily hear the audibly-reproduced engine sound, or installed outside the actual vehicle R so that the engine sound is emitted out of the vehicle.

### <Modification 1>

Whereas the foregoing have described the embodiment of the present invention, the present invention may be embodied in various other manners. For example, whereas the above-described embodiment is constructed to generate or acquire information of the number of engine rotations, accelerator opening degree and presence/absence of a shift change on the basis of vehicle velocity information of the actual vehicle R, such information of the number of engine rotations, accelerator opening degree and presence/absence of a shift change may be acquired from sensors provided on the actual vehicle R. In such a case, it is desirable that each of these sensors output, to the processing section 40, information detected thereby in a cyclic period shorter than the above-mentioned period C2 with which to generate engine sound.

FIG. 14 is a block diagram showing an overall construction of an engine sound apparatus 10a according to Modification 1 of the present invention. This modified engine sound apparatus 10a includes a detection section group 20a that includes a number-of-rotation detection section 230a, an opening degree detection section 240a and a shift change detection section 250a. The number-of-rotation detection section 230a includes a sensor for detecting the number of rotations, and this sensor is provided on a portion of the actual vehicle R which rotates in response to operation of the prime mover of the vehicle R. The number-of-rotation detection section 230a acquires information indicative of engine rotations in response to the number of rotations detected by the sensor. The number-of-rotation detection section 230a outputs the thus-acquired number of rotations of the prime mover to the processing section 40. The opening degree detection section 240a includes a sensor for detecting an accelerator opening degree, and this sensor is provided on the accelerating control operable by the human driver for opening the accelerator opening degree. The opening degree detection section 240a outputs the accelerator opening degree, detected via the sensor, to the processing section 40. Note that the sensor for detecting an accelerator opening degree may be provided on an accelerator valve of the prime mover.

The shift change detection section 250a includes a sensor for detecting that a shift change of the transmission has been effected by the human driver or through automatic control. Once a shift change is effected, the shift change detection section 250a outputs, to the processing section 40, a signal indicating that a shift change has been effected. Upon receipt of such a signal, the processing section 40 performs the above-described accelerator opening degree acquiring operations of steps S5220 and S330 shown in FIG. 12.

### <Modification 2>

Whereas the above-described embodiment of the engine sound generation apparatus 10 is constructed to generate a shift-up accelerator opening degree as the accelerator opening degree upon judging that an upshift of the transmission has been effected, a modified engine sound generation apparatus may perform an accelerator opening degree generating process as if there were no shift change. A racing car, for example, effects an upshift in response to upshift operation without returning the accelerator and hence with the accelerator kept open.

Thus, in the case where the model vehicle M is a racing car, the engine sound generation apparatus 10 may operate to generate an accelerator opening degree on the basis of a vehicle velocity change tendency value even when there has been a shift change, as long as the shift change is an upshift of the transmission.

### <Modification 3>

Whereas the above-described embodiment of the engine sound generation apparatus 10 is constructed to reproduce fluctuation when generating the number of engine rotations, such fluctuation may be reproduced at the time of generation of engine sound. In this case, the engine sound generation section 50 only has to use random numbers to fluctuate timing for reproducing generated engine sound data. The following explain the modification, for example, in relation to a case where engine sound based on engine sound data, generated on the basis of the number of engine rotations R(n) and accelerator opening degree A(n) that are generated based on vehicle velocity information detected at time t(n), is audibly reproduced through an external speaker or the like at time point t(n+α). “α” indicates a time required from the time when the engine sound generation section 50 outputs the engine sound data to the time when the external speaker or the like audibly reproduces the engine sound data. In this case, the engine sound generation section 50 may generate a random number value in a range from zero to the maximum value of a predetermined fluctuation width (such a random number value will hereinafter be referred to as “fluctuation value F”), and output the engine sound data at time point delayed by the fluctuation value F (i.e., at time point t(n+F)).

### <Modification 4>

Whereas the above-described embodiment is arranged to acquire the reference accelerator opening degree BA using the table T2, the reference accelerator opening degree BA may be acquired using the following equation:

Reference Accelerator Opening Degree BA=Vehicle Velocity×β+γ

where β and γ are constants predetermined in accordance with the characteristics of the model vehicle M and prestored in the fixed-gear-time accelerator opening degree setting information 340. In this case, upon a YES determination at step S270 of FIG. 12, the processing section 40 calculates the reference accelerator opening degree BA using vehicle velocity information last accumulated at step S240 and these constants β and γ.

### <Modification 5>

Whereas the above-described embodiment is arranged to determine a shift change on the basis of the gear information, the processing section 40 may accumulate the number-of-engine-rotation information and determine a shift change on the basis of a rate of change of the accumulated number-of-engine-rotation information. For example, the processing section 40 may determine a shift change as follows. Namely, the processing section 40 acquires the number of engine rotations and stores the acquired number of engine rotations into the RAM 430 at step S200 of FIG. 12. By repetition of the operations of FIG. 12, a plurality of the numbers of engine rotations are accumulated into the RAM 430. Then, the processing section 40 converts a rate of change in the accumulated numbers of engine rotations into a numerical value.

Generally, when a downshift of the transmission is effected, the number of engine rotations, having been decreasing, rapidly shifts to increase once the engine is connected to a changed-to (shifted-to) gear, as seen in FIG. 10. When an upshift of the transmission is effected, on the other hand, the number of engine rotations, having been increasing, rapidly shifts to decrease because the human driver returns the accelerator before disconnecting the transmission. The processing section 40 detects a rapid change in the number of engine rotations from accumulated number-of-engine-rotation information. For example, the processing section 40 compares the last acquired number of engine rotations and the second last acquired number of engine rotations and between the second last acquired number of engine rotations and the third last acquired number of engine rotations. Then, the processing section 40 calculates absolute values of the differences between the compared numbers of engine rotations, and judges that a shift change has been effected if the absolute values are greater than a predetermined value.

### <Modification 6>

As a modification, a virtual vehicle velocity may be calculated by a human operator setting a maximum velocity of the actual vehicle R used for calculation of a virtual vehicle velocity in the above-described embodiment. In this case, the human operator operates the operation section 60 to enter a vehicle velocity value corresponding to operating states of the vehicle as a setting, in the vehicle velocity region setting information 320, of the maximum velocity of the actual vehicle R. For example, in a case where the vehicle travels on an express way where the speed limit is fixed at 100 km/h, the human operator inputs and sets a value “100” (km/h) as the maximum velocity. Through such setting, the human operator can feel engine sound at the maximum velocity of the model vehicle M by driving at 100 km/h.

### <Modification 7>

Whereas the above-described embodiment is arranged to set the relationship between vehicle change tendencies and accelerator opening degree correction values in the manner as indicated in the table T1, such relationship between vehicle change tendencies and accelerator opening degree correction values may be set in accordance with the engine sound data stored in the engine sound data storage section 510. Assume, for example, that engine sound data of the model vehicle M requiring a greater accelerator operating amount are stored in the engine sound data storage section 510. In such a case, it is only necessary that the accelerator opening degree correction values be set greater than those stored in the table T1.

### <Modification 8>

The actual vehicle R only has to be a vehicle provided with a prime mover, such as an engine-powered vehicle, electric vehicle or hybrid vehicle having a manual transmission or automatic transmission, or a motorcycle. In the case where the actual vehicle R is a motorcycle, the above-mentioned external speaker or the like is provided, for example, inside a helmet and emits sound so that the sound can be heard by a human driver. In order to generate engine sound of the model vehicle M, the engine sound generation apparatus 10 generates information indicative of the number of engine rotations and accelerator opening degree on the basis of vehicle velocity information and acceleration information of the actual vehicle R. In the case where the actual vehicle R is an electric vehicle, it does not actually cause the engine to rotate and open the accelerator to adjust a fuel supply amount. However, in such a case too, the engine sound generation apparatus 10 generates information indicative of the number of engine rotations and accelerator opening degree on the basis of vehicle velocity information and acceleration information of the actual vehicle R, in order to generate engine sound of the model vehicle M. In the case where the actual vehicle R is an electric vehicle too, the human driver causes the actual vehicle R to travel by using the accelerating control, such as an accelerator pedal, to adjust the rotation of the prime mover, i.e. motor. The engine sound generation apparatus 10 may detect the number of rotations of the motor or detect an operated amount of a control that operates the motor, and use the detected number of rotations or operated amount as information for generating engine sound. Thus, even where the actual vehicle R is an electric vehicle, it travels in accordance with states of operation by the human driver. Thus, even engine sound based on a virtual number of engine rotations and accelerator opening degree, the human driver can feel the virtual engine sound as engine sound generated by the human driver's driving, as long as the virtual engine sound is generated in accordance with the states of operation by the human driver.

### <Modification 9>

Whereas the above-described embodiment of the engine sound generation apparatus 10 is arranged to generate synthesized engine sound data using the engine sound data stored in the engine sound data storage section 510, synthesized engine sound data may be generated on the basis of an updated accelerator opening degree value, or generated or acquired number-of-engine-rotation information. In this case, original engine sound data may be created in advance using a sound generator, such as an FM (Frequency Modulation) sound generator or analog modeling sound generator. The engine sound generation apparatus 10 may generate engine sound data of the model vehicle M by processing the original engine sound data using information of an accelerator opening degree and number of engine rotations as parameters.

### <Modification 10>

Whereas the above-described embodiment of the engine sound generation apparatus 10 is arranged to use engine sound data corresponding to the number of engine rotations and accelerator opening degree, the engine sound generation apparatus 10 may use engine sound data corresponding only to the acquired number of engine rotations. In this case, the engine sound generation apparatus 10 generates synthesized engine sound data using the engine sound data engine sound data storage section 510 and on the basis of the acquired number-of-engine-rotation information. Alternatively, the engine sound generation apparatus 10 may use engine sound data corresponding only to an updated accelerator opening degree. In such a case, the engine sound generation apparatus 10 generates synthesized engine sound data using the engine sound data engine sound data storage section 510 and on the basis of the updated accelerator opening degree value.

The present application is based on, and claims priority to, Japanese Patent Application No. 2009-236591 filed on Oct. 13, 2009. The disclosure of the priority application, in its entirety, including the drawings, claims, and the specification thereof, is incorporated herein by reference.

What is claimed is:

1. An engine sound generation apparatus comprising:
a velocity detection section which detects a velocity of an actual vehicle;
a velocity conversion section which converts the velocity, detected by said velocity detection section, into a virtual velocity on the basis of a first particular velocity specified within a traveling velocity range of the actual vehicle and a second particular velocity specified within a traveling velocity range of a pre-assumed model vehicle;
a number-of-engine-rotation generation section which, on the basis of the virtual velocity, generates information indicative of a number of engine rotations of the model vehicle; and
an engine sound generation section which generates synthesized engine sound data corresponding to the number of engine rotations of the model vehicle.

2. The engine sound generation apparatus as claimed in claim 1, wherein said engine sound generation section includes an engine sound data storage section storing therein engine sound data corresponding to the number of engine rotations of the model vehicle, and said engine sound generation section uses the engine sound data, stored in the engine sound data storage section, to generate the synthesized engine sound data corresponding to the information indicative of a number of engine rotations of the model vehicle generated by said number-of-engine-rotation generation section.

3. The engine sound generation as claimed in claim 2, which further comprises a velocity-vs.-number-of-rotation correspondence relationship storage section which stores therein correspondence relationship between traveling velocities and numbers of engine rotations of the model vehicle, and
wherein said number-of-engine-rotation generation section generates the information indicative of a number of engine rotations of the model vehicle on the basis of the correspondence relationship stored in said velocity-vs.-number-of-rotation correspondence relationship storage section and the virtual velocity determined by said velocity conversion section.

4. The engine sound generation section as claimed in claim 3, wherein said velocity-vs.-number-of-rotation correspondence relationship storage section stores therein correspondence relationship between traveling velocities and numbers of engine rotations of the model vehicle in association with individual ones of a plurality of gear positions,
said number-of-engine-rotation generation section changes the gear positions and selects one of the correspondence relationship, stored in said velocity-vs.-number-of-rotation correspondence relationship storage section, in such a manner that an upshift or downshift of a transmission is effected at a predetermined vehicle velocity in response to increase or decrease of the virtual velocity, said number-of-engine-rotation generation section changing the gear positions with a hysteresis such that a vehicle velocity at which a downshift from one gear position is effected is smaller than a vehicle velocity at which an upshift to the one gear position is effected.

5. The engine sound generation apparatus as claimed in claim 3, which further comprises an acceleration detection section which detects acceleration of the actual vehicle, and
wherein said velocity-vs.-number-of-rotation correspondence relationship storage section stores therein correspondence relationship between traveling velocities and numbers of engine rotations of the model vehicle in association with individual ones of a plurality of gear positions,
said number-of-engine-rotation generation section changes the gear positions and selects one of the correspondence relationship in such a manner that an upshift or downshift of a transmission is effected at a predetermined vehicle velocity in response to increase or decrease of the virtual velocity, and, when an absolute value of the acceleration detected by said acceleration detection section is smaller than a preset value, said number-of-engine rotation generation section lowers a vehicle velocity, at which the upshift or downshift is to be effected, within a range where the number of engine rotations does not fall below a preset number.

6. The engine sound generation apparatus as claimed in claim 1, which further comprises a random number generation section which generates random numbers within a predetermined range, and
wherein said number-of-engine-rotation generation section imparts fluctuation to the number of engine rotations of the model vehicle on the basis of the random numbers generated by said random number generation section.

7. The engine sound generation apparatus as claimed in claim 1, which further comprises an input section operable by a human operator to input said first particular velocity, and where said second particular velocity is a maximum velocity of the model vehicle.

8. The engine sound generation apparatus as claimed in claim 1, which further comprises an accelerator opening degree detection section which detects an accelerator opening degree of the actual vehicle, and
wherein said engine sound generation section generates synthesized engine sound data corresponding to the number of engine rotations and the accelerator opening degree of the model vehicle.

9. The sound generation apparatus as claimed in claim 8, wherein said engine sound generation section includes an engine sound data storage section storing therein engine sound data corresponding to the number of engine rotations and the accelerator opening degree of the model vehicle, and said engine sound generation section uses the engine sound data, stored in the engine sound data storage section, to generate synthesized engine sound data corresponding to the number of engine rotations and the accelerator opening degree of the model vehicle.

10. A computer-implemented method for generating engine sound, comprising:
a detection step of detecting a velocity of an actual vehicle;
a step of converting the velocity, detected by said detection step, into a virtual velocity on the basis of a first particular velocity specified within a traveling velocity range of the actual vehicle and a second particular velocity specified within a traveling velocity range of a pre-assumed model vehicle;
a step of, on the basis of the virtual velocity, generating information indicative of a number of engine rotations of the model vehicle; and
a step of generating synthesized engine sound data corresponding to the number of engine rotations of the model vehicle.

11. The method as claimed in claim 10, wherein said step of generating synthesized engine sound data includes a step of accessing an engine sound data memory storing therein engine sound data corresponding to the number of engine rotations of the model vehicle to generate said synthesized engine sound data corresponding to the number of engine rotations of the model vehicle.

12. The method as claimed in claim 10, wherein said step of generating information indicative of a number of engine rotations of the model vehicle includes:
a step of accessing a velocity-vs.-number-of-rotation correspondence relationship memory storing therein correspondence relationship between traveling velocities and numbers of engine rotations of the model vehicle, and
a step of generating, on the basis of the correspondence relationship stored in the velocity-vs.-number-of-rotation correspondence relationship memory and the virtual velocity determined by said converting the velocity, the information indicative of a number of engine rotations of the model vehicle.

13. A computer-readable storage medium containing a program for causing a computer to perform a method for generating engine sound, said method comprising:
a detection step of detecting a velocity of an actual vehicle;
a step of converting the velocity, detected by said detection step, into a virtual velocity on the basis of a first particular velocity specified within a traveling velocity range of the actual vehicle and a second particular velocity specified within a traveling velocity range of a pre-assumed model vehicle;
a step of, on the basis of the virtual velocity, generating information indicative of a number of engine rotations of the model vehicle; and
a step of generating synthesized engine sound data corresponding to the number of engine rotations of the model vehicle.

14. The computer-readable storage medium as claimed in claim 13, wherein said step of generating synthesized engine sound data includes a step of accessing an engine sound data memory storing therein engine sound data corresponding to the number of engine rotations of the model vehicle to generate said synthesized engine sound data corresponding to the number of engine rotations of the model vehicle.

15. The computer-readable storage medium as claimed in claim 13, wherein said step of generating information indicative of a number of engine rotations of the model vehicle includes:
a step of accessing a velocity-vs.-number-of-rotation correspondence relationship memory storing therein correspondence relationship between traveling velocities and numbers of engine rotations of the model vehicle, and
a step of generating, on the basis of the correspondence relationship stored in the velocity-vs.-number-of-rotation correspondence relationship memory and the virtual velocity determined by said converting the velocity, the information indicative of a number of engine rotations of the model vehicle.
